(19) United States
(12) Patent Application Publication
(10) Pub. No.: US 2002/0091839 A1
(43) Pub. Date: Jul. 11, 2002

(54) Live switch device enabling log off and log on without disconnection from ISP or server-side

(76) Inventors: Kokoro Imamura, La Jolla, CA (US); Srikant Char, Poway, CA (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 09/908,393

(22) Filed: Jul. 18, 2001

Related U.S. Application Data
(60) Provisional application No. 60/260,117, filed on Jan. 8, 2001.

(51) Int. Cl. G06F 15/16

(52) U.S. Cl. 709/228

(57) ABSTRACT

A live switch application executes between the user (e.g., the client device and its applications) and the POP or host server. The live switch application serves to maintain the connection between the POP or host server and interacts with the POP or host server during an authenticating process to authenticate the user. By providing an efficient and effective process to reduce the number of steps (and therefore the time) needed to login to a server, the present invention enables use of a common device or Internet appliance by many users. This provides the ability of many users of a common terminal to access the Internet without unduly inconveniencing the users by a shared terminal.

### RELATED APPLICATIONS

This application claims priority to U.S. Provisional Application No. 60/260,117 filed on Jan. 5, 2001 by the same inventors.

### COPYRIGHT NOTICE

At least a port of the disclosure of this patent document may contain material that is subject to copyright protection. In such case, the copyright owner has no objection to the facsimile reproduction of the patent document or the patent disclosure, as it appears in the U.S. Patent & Trademark Office patent file or records, but otherwise reserves all copyright rights whatsoever.

### BACKGROUND OF THE INVENTION

The present invention relates generally to methods and apparatuses for connecting to an Internet Service Provider or other server application from a device on a client side, and more particularly, to a method and apparatus for connecting to an Internet Service Provider or other server application from a device on a client side serving multiple users.

When one couples to an Internet Service Provider (ISP), depending upon the connection method, multiple steps usually occur in the process. For example, when using a dial-up modem connection, a user typically enters his or her user identification and password as part of an initial login process, which information is eventually transmitted to a Point of Presence (POP) server of the ISP. Subsequently, the computer automatically dials a telephone number assigned to the point-of-presence (POP) or host server for the ISP. Next, the user's computer and the POP or host server establish communications protocols, and then communicate the user's identification and password information as part of a user authentication process. Once these steps are complete, the user is considered authenticated and the user can then begin accessing information or programs provided by the POP or host server.

When the authenticated user logs out, the above steps, including the dialing of the telephone number and the establishing of communications protocols, must be repeated for a subsequent user to access the same host or POP server, even though the subsequent user may be logging on immediately as the first user logs off. Moreover, if the user simply wishes to log off for a short period of time for security purposes, the above steps must be repeated when the user returns. This greatly inconveniences users who wish to access the Internet quickly on a frequent basis. As more and more applications for the Internet become ingrained in daily life, such inconveniences serve to limit the usefulness of Internet devices.

The present invention is therefore directed to the problem of developing a method and apparatus for avoiding redundant steps in the above-described login process and improving the efficiency of new log-ins.

### SUMMARY OF THE INVENTION

The present invention solves these and other problems by providing a live switch application that executes between the user (e.g., the client device and its applications) and the POP or host server, which live switch application serves to maintain the connection between the POP or host server and interacts with the POP or host server during an authenticating process to authenticate the user.

By providing an efficient and effective process to reduce the number of steps (and therefore the time) needed to login to a server, the present invention enables use of a common device or Internet appliance by many users. In the past, such devices were limited by the inconvenience of long initialization and login processes, or were limited to certain applications where the connections were based on local area networks or other computer network systems. Such systems are significantly more complex than dial-up modems, often requiring expertise and knowledge by the user beyond that of many computer users. Consequently, the present invention provides the ability of many users of a common terminal to access the Internet without unduly inconveniencing the users by a shared terminal.

### BRIEF DESCRIPTION OF THE DRAWINGS

FIG. 1 depicts an exemplary embodiment of a multi-user environment to which the present invention is applicable.

FIG. 2 depicts an exemplary embodiment of a method according to one aspect of the present invention.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

According to one aspect of the present invention, a method for maintaining a connection between a user's device and a host server enables avoidance of redundant login steps once an initial login has occurred. This method applies to any device capable of communicating with a host server via a computer connection, such as a dial-up modem, local area network connection, wide area network connection or dedicated connection, in which the connection is severed when a user logs out.

Various embodiments of techniques for implementing the above method are possible. For example, one embodiment includes creating a default user identification account and password to which the system defaults if the user wishes to temporarily log off or wishes to partially log off because, for example, another user wishes to login. The default user identification account is unique for the particular device accessing the host server. This account does not enable the device to access any programs or information on the host server, but merely exists in a wait state until another authorized user enters proper user identification and password information.

This default account can exist at the host server and be controlled by server permissioning level controls, for example. Such permissioning levels allow a server to assign specific levels of access to each user. By creating a level of access that does not allow the user to do anything except login, the server can ensure that the default user merely can login and then hold the communication line or connection.

Alternatively, the control over the default account can exist on the user's device. The client application can lockout commands from being transferred to the host server except for new login attempts after the client application has authenticated these new users from a list of authorized users of the device for accessing the host server. Thus, the client application could keep the device in an authentication loop that prevents any action by the device until a user enters login information that is authenticated by the client application, thereby enabling the device to exit the authentication loop, log out the default user and present this login information to the host server without disrupting the communication link.

Thus, there is provided a convenient device for coupling a preceding user with succeeding user without disconnecting the coupled to an Internet Service Provider (ISP) or another service side connection.

The present invention enables a constant or continuous connection to the ISP without severing the connection when one user logs off. The present invention enables multiple users to log on while avoiding the additional steps of dialing up and establishing the communication link between the user's computer and the server application or host. The present invention therefore saves time and makes it significantly more convenient for multiple users to log. Moreover, by providing an easy way to log out and back in, the present invention actually improves security because it enables user to log off when temporarily leaving their workstation without incurring an inefficiency penalty that would otherwise occur.

In an example according to one embodiment of the above device, there is provided a “live switch application” that exists locally on the computer or is stored on the server side. When a user logs out, the live switch application is activated. Upon activation, for example, the user may be queried as to “whether or not the user intends to log out completely.” If the response is not affirmative, meaning the user does not intend to logout completely, the main screen is returned without severing the ISP connection. Thereupon, another different user could log in simply by selecting his name and entering a password. Therefore, the additional step of establishing a coupling with the ISP through, e.g., a dial-up modem, is eliminated. Hence, such a “live switch device” provides a convenient way to coupled a preceding and succeeding user without disconnecting an ISP connection.

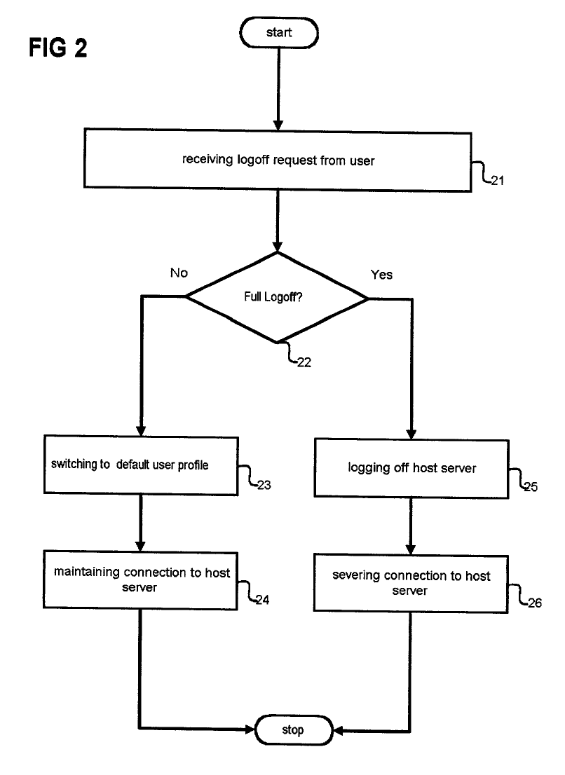

Another embodiment of the present invention shown in FIG. 2 employs a two-step log out process. According to this aspect of the present invention, in response to a logoff request from a user 21, a user is queried as to whether the user wishes a full or partial logout 22. If the user indicates a full logout, the connection to the remote terminal is severed 26 upon logging off from the host server 25. If the user indicates a partial logout is preferred, the connection to the remote terminal is maintained 24, and the device is locked out, except for the ability to enter a new user identification and password. Once a new user logs in, the device allows full functioning and the new user's information is transferred to the remote server in lieu of the prior user (or default user). The user profile may be switched to a default user profile 23 as part of this process.

According to yet another aspect of the present invention, the terminal includes a dedicated key on the keyboard that when activated logs the user off but maintains the connection. Thus, a partial logout key is employed on the device's keyboard. Another dedicated key may be used to initiate a complete log off and severance of the connection to the remote server or terminal.

According to yet another aspect of the present invention, when the device is first turned on (e.g., from a cold boot), the device contacts the ISP host and performs its default log in, preferably in the background so that the user is oblivious to this process. Once in this default log in state, the device does not accept commands for transfer to the host, except for user identification and password information. This prevents unauthorized access to the host server while enabling rapid log in for any subsequent user.

According to yet another aspect of the present invention, there are provisions for a primary user and multiple secondary users. The secondary users piggyback on the primary user's ISP account. When the device first starts up, the device logs onto the ISP server using the primary user's identification and password information, which is obtained during a registration process when the device is first setup and turned on. The live switch application prevents further access to the ISP server until the primary user (or one of the secondary users) enters his user identification and password. The primary user then can access the Internet in the normal manner.

User identification and passwords are provided to the secondary users by the primary user as part of a registration process. Once there are provided to the secondary user and stored on the primary user's account, the secondary users can access the ISP server in the normal manner.

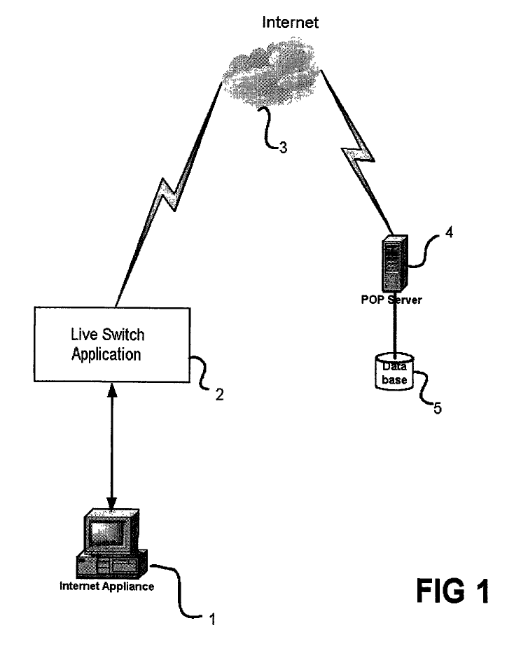

The present invention finds ready application in a consumer Internet appliance, e.g., the Sony eVilla Network Entertainment Center, which is a consumer information system that is designed to provide easy Internet access from the home environment. FIG. 1 depicts an exemplary embodiment of a system in which the Internet Appliance 1 operates. The live switch application 2 controls the connection to the Internet 3. The ISP POP server 4 and associated database 5 controls the users' access to the Internet 3. The system 1 is a lower cost solution than a personal computer and relies upon a business model that produces revenues from content partners and advertising placement.

The Internet appliance of the present invention system provides multiple levels of user interfaces. A Level 1 user interface offers advanced functionality to inexperienced users without the user having to configure the system or software. The Level 1 user interface is designed to be simple, intuitive, uncluttered, and easily navigated. A Level 2 user interface allows the more experienced user to configure the applications and functions for a more customized appearance and function.

The embodiment of the present invention is actively connected to the Internet via a 56 k Modem, for example. The embodiment can get into the Online mode from a Offline mode by one of the following ways (the user is always asked to Confirm if he wishes to Connect to the Internet):

User clicks on a Bookmark on the Web context;

User clicks on a web link on a NetGuide category page;

User clicks on a web link on a Web Context page;

User clicks on the SendMail icon in a Compose Mail operation;

User clicks on Inline web link that's embedded in a e-mail message body;

User clicks on a Attachment icon in the E-mail message; or

User clicks on a Preset IRadio/IChannels link.

In the Offline mode the system is not connected to the Internet and could be in a System Standby or System Power On mode. The 56 k modem is passive. The system can get into this mode from the Online state in one of the following ways:

User selects the HangUp button to disconnect his Web interaction; or

The phone line automatically disconnects the user due to a variety of reasons.

There are at least two user types for this device, Primary and Secondary users. The Primary User is the individual who first registers the device and establishes the required ISP account. The UserID information for the Primary User will be used to authenticate the system. Secondary users (up to three) have their own e-mail addresses and identities, but are “piggybacked” on the Primary User for authentication purposes.

The device can be placed in security access mode. If Security Access is enabled (multi-user) then the User Login dialog box is displayed before dialing out and opening the home page. If the Auto Dialout option is enabled then, the device dials out to the ISP and executes the Download HomePage function for the current user.

First Time Registration Process

In the First Time Registration process, it is assumed that prior to initial power up:

The device has been removed from all packing materials.

The power cord has been inserted into the appropriate port on the device and is connected to the appropriate power source.

The telephone line has been attached to the appropriate port on the device.

The keyboard and mouse have been attached to the appropriate ports.

The front panel Power On button has not been pushed.

When the front panel Power On button is pushed for the initial power on instance, the device depicts a Welcome screenshot. The user is given two options, 1) Register; 2) Learn More. If the user selects the Register option, then the device initiates a Dial Out function to the Sony 800 number for the Registration Server and shows a message about this to the user. If the 800 Registration number is busy, the application will show the user a message indicating so. If the device detects a bad phone connection, the application will show a message indicating so to the user. Similarly, if the Registration Server refuses to accept the connection, the application will inform the user. If the Registration Server is out of service or busy, then the application informs the user of this. If the user attempts to stop the Registration process before it is completed, then the application will prompt the user to either Cancel, which returns the user to Registration or Exit, which stops the Registration process and returns the user to the Welcome screen.

If a connection is established, then the Sony server, which acts as a Proxy between the eVilla device and the ISP registration server, will redirect the connection to the appropriate ISP Registration Server. If the device accepts the redirection, and the connection to the ISP Registration Server is made, then the ISP Registration page(s) will be rendered. The ISP registration server performs registration dialog and sends HTML replies to the eVilla client. The user will always be given the opportunity to opt out. Next, the device is then queried by the Server, using the Binder API protocol, for unique identity information, i.e., eVilla Device Identification. During the user's successful registration with the ISP, the Sony Server will accumulate user account information using the Binder API protocol. Upon completion of a successful registration, the Sony eVilla Server will use XML-RDBMS mapping to save XML Account object in Oracle and uses XML-to-HTML/JavaScript mapping schema, the Account object and the ISP object to build HTML/JavaScript to initialize eVilla client settings in flash memory. The eVilla Server will then send a final HTML/JavaScript to the eVilla device and sends a settings confirmation request to the eVilla Server. The eVilla Server will then update the Account object to indicate that Account information on both Server and Client is synchronized and sends HTML/JavaScript to the eVilla device telling it to disconnect the DialOut connection. The user is then informed of the successful operation.

Normal Access Process

Normal (Registered) User—System Boot Module

Assumptions:

The Client system has a Primary-user, OR,

The system is recovering from a lost power state from a prior operation

General requirements:

Check if Software Recovery Flag is enabled and if NOT, then,

Check if Primary-user exists on the Client system and if YES,

Bring up Client system into the ‘eVilla Space’ context

Bring up Client system in a default, SecurityAccessDisabled state (anyone has access to the system)

Display eVillaUI-Msg0500 to indicate Name of Primary User.

Net Connect/Hangup Module

Connect Functionality (Single or Multi-User)

This function connects the device to the Internet going from an Offline state to an Online state. The function is invoked via any one of several eVilla device events when in Offline state, i.e., Weblinks, Front Panel buttons and eVilla applications. A list of possible triggers that invoke this function is given below:

Web context:

Clicking on the “Login to the Net” link on the default offline Web page

Clicking on a bookmark whilst Offline

If “Auto Dialout” is enabled in the Configuration Panel then pushing the ‘Web’ Front Panel button in a Offline mode must invoke this function

Email context:

Clicking on the GetMail/SendMail button in an Offline mode

If “Auto Dialout” is enabled in the Configuration Panel then pushing the ‘Email’ Front Panel button in an Offline mode must invoke this function

NetGuide:

Clicking on the “Login to the Net” link on a main category page of

NetGuide

Clicking on any NetGuide category page Weblink when Offline.

Scheduled Download:

Via the ‘Scheduled Download’ application when Offline

No matter how it gets invoked the function essentially must process two actions in order to connect the device/user to the Internet; viz;

DialOut (to ISP), and,

Authenticate user.

DialOut State

In this state, the device attempts to DialOut to the ISP using the preset, primary POP Access telephone number.

The user is shown a message—“Attempting to connect” —during this step. The device will automatically retry DialOut 3 times if the telephone line is busy. After 3 retries, the device prompts the user with a message as to whether the user wishes to ‘ContinueDialOut’ again or ‘CancelDialOut’. The above process is repeated if the user chooses to Continue. If user chooses to ‘CancelDialOut’ then the user is kept in the same context and the DialOut process ends.

Display HangUp Button

If successful connection is established then, the user is shown the ‘HangUp’ button.

User Authentication

If a connection is made, then the device sends the Primary-user's Authentication information (e.g., Account UserName/Password) to the requesting ISP and awaits ISP acknowledgement.

The user is shown a system status message about ISP authentication request.

Authentication Failure

If Authentication failed (e.g., based on an incorrect UserName/Password combination) then the user is shown a dialog as to why the current login attempt failed. The user is then queried as to if he wishes to retype his UserName/Password, which might be different due to an account change.

Hangup Functionality (Single User Implementation)

This function disconnects the device from the Internet, going from an Online state to an Offline state. The function is invoked via the “Hangup” button.

Local Web Cache

According to another aspect of the present invention, the local web cache is designed as a ring buffer that will overwrite itself, with no user notification or intervention, when available space is used. The web cache will be cleared each time a user logs off.

Although various embodiments are specifically illustrated and described herein, it will be appreciated that modifications and variations of the invention are covered by the above teachings and within the purview of the appended claims without departing from the spirit and intended scope of the invention. For example, while several of the embodiments depict the use of specific data formats and protocols, any formats or protocols may suffice. Moreover, while some of the embodiments describe specific embodiments of computer, clients, servers, etc., other types may be employed by the invention described herein. Furthermore, these examples should not be interpreted to limit the modifications and variations of the invention covered by the claims but are merely illustrative of possible variations.

What is claimed is:

1. A method for accessing a host server from a client application comprising:
establishing a default user account on the host server;
switching to the default user account upon a user logging out of the host server; and
maintaining a connection to the host server from the client application when the default user is logged on.

2. The method according to claim 1, further comprising querying the user as to whether the user wishes to perform a partial logoff or a full logoff in response to a logoff command.

3. The method according to claim 2, further comprising switching to the default user logon profile in response to a partial logoff reply from the user.

4. The method according to claim 2, further comprising switching to the default user account and maintaining a connection to the host server in response to a partial logoff reply from the user.

5. The method according to claim 2, further comprising severing the connection to the host server in response to a full logoff reply from the user.

6. The method according to claim 1, further comprising logging on the host server as the default user during a power up sequence of the client application.

7. The method according to claim 1, further comprising providing a dedicated key on an input terminal of a device executing the client application that when activated initiates a partial logoff of a current user.

8. The method according to claim 1, further comprising performing a complete logoff upon activation of a dedicated key on an input terminal of the client device by a current user.

9. The method according to claim 1, further comprising caching local web data in a ring buffer that overwrites itself when available space is used.

10. The method according to claim 9, further comprising clearing the local web data each time a user logs off.

11. A method for accessing a host server from a client application comprising:
querying a user as to whether the user wishes to perform a partial logoff or a full logoff in response to a logoff command;
maintaining a connection to the host server in response to a partial logoff reply from the user; and
severing the connection to the host server in response to a full logoff reply from the user.

12. The method according to claim 11, further comprising switching to a default user logon profile in response to the partial logoff reply from the user.

13. The method according to claim 11, further comprising logging on the host server as the default user during a power up sequence of the client application.

14. The method according to claim 11, further comprising providing a dedicated key on an input terminal of a device executing the client application that when activated initiates a partial logoff of a current user.

15. The method according to claim 11, further comprising performing a complete logoff upon activation of a dedicated key on an input terminal of the client device by a current user.

16. The method according to claim 11, further comprising caching local web data in a ring buffer that overwrites itself when available space is used.

17. The method according to claim 16, further comprising clearing the local web data each time a user logs off.

18. A method for accessing a host server from a client device comprising:
providing a default user logon profile enabling the device to logon to the host server but without a capability to transmit other commands or information to the host, except for a new user profile; and
switching to the default user account upon a user logging out of the host server.

19. The method according to claim 18, further comprising logging on the host server as the default user during a power up sequence of the client device.

20. The method according to claim 18, further comprising maintaining the connection to the host upon switching to the default user account.

21. The method according to claim 18, further comprising providing a dedicated key on an input terminal of the device that when activated initiates a partial logoff of a current user.

22. The method according to claim 18, further comprising performing a complete logoff upon activation of a dedicated key on an input terminal of the client device by a current user.

23. The method according to claim 18, further comprising caching local web data in a ring buffer that overwrites itself when available space is used.

24. The method according to claim 18, further comprising clearing the local web data each time a user logs off.

25. A computer readable medium having encoded thereon instructions causing a processor to:
query a user as to whether the user wishes to perform a partial logoff or a full logoff in response to a logoff command;
maintain a connection to a host server in response to a partial logoff reply from the user; and
sever the connection to the host server in response to a full logoff reply from the user.

26. A computer process operable to control a connection between a client application and a host server comprising:
intercepting a logoff command from the client application to the host server;
querying the client application as to whether a complete logoff is preferred or a partial logoff is preferred;
maintaining a connection to a host server in response to a partial logoff reply; and
severing the connection to the host server in response to a full logoff reply.

27. The process according to claim 26, further comprising switching to a default user profile as part of the maintaining the connection to the host server.
